(19) United States
(12) Patent Application Publication
(10) Pub. No.: US 2012/0113065 A1
(43) Pub. Date: May 10, 2012

(54) STYLUS INPUT DEVICE

(75) Inventor: Jimmy CHIN, New TaipeI City (TW)

(73) Assignee: UC-Logic Technology Corp., New Taipei City (TW)

(21) Appl. No.: 13/288,626

(22) Filed: Nov. 3, 2011

(30) Foreign Application Priority Data
Nov. 5, 2010 (TW) 099138137

(51) Int. Cl. G06F 3/033

(52) U.S. Cl. 345/179

(57) ABSTRACT

A stylus input device includes a grip, a surface-contacting member, a pivot joint, and first and second sensor modules. The pivot joint is disposed to connect the grip to the surface-contacting member and permit tilting of the grip relative to a working surface when the surface-contacting member is in intimate contact with the working surface, and is configured to permit and guide axial displacement of the grip relative to the surface-contacting member. The first and second sensor modules are disposed respectively in the surface-contacting member and the grip for sensing two-dimensional movement of the surface-contacting member on the working surface and axial displacement of the grip so as to respectively generate a two-dimensional movement signal and an axial displacement signal that are to be converted into a positioning signal by a processing unit for subsequent transceiving by a transmitting module.

### CROSS-REFERENCE TO RELATED APPLICATION

This application claims priority of Taiwanese application No. 099138137, filed on Nov. 5, 2010.

### BACKGROUND OF THE INVENTION

1. Field of the Invention

This invention relates to a stylus input device, more particularly to a stylus input device capable of generating a three-dimensional input signal.

2. Description of the Related Art

Referring to FIG. 1, a conventional stylus input device 8 is operable for movement on a touch panel 9. The stylus input device 8 includes a resonant circuit (not shown) being configured to generate a resonant frequency.

The touch panel 9 includes a sensing antenna 92 and a processing unit 93. The sensing antenna 92 is disposed in the touch panel 9 for sensing resonant frequency generated by the resonant circuit when the stylus input device 8 moves on the touch panel 9, and generates a two-dimensional signal, i.e., X-Y coordinate data of the stylus input device 8, according to the resonant frequency sensed thereby. The processing unit 93 is electrically connected to the sensing antenna 92 for receiving the two-dimensional signal and generating a positioning signal.

However, the conventional stylus input device 8 is designed for use with a touch panel that includes a sensing antenna and a processing unit, which results in inconvenience and increased manufacturing costs. Additionally, an axial displacement of the stylus input device 8 relative to the touch panel 9 is not detected.

### SUMMARY OF THE INVENTION

Therefore, the object of the present invention is to provide a stylus input device capable of overcoming the above drawbacks of the prior art.

According to this invention, a stylus input device operable for movement on a working surface comprises a grip, a surface-contacting member, a pivot joint, first and second sensor modules, a processing unit, and a transmitting module. The grip defines an axis, and the surface-contacting member has an end wall configured for intimate contact with the working surface. The pivot joint is disposed to connect pivotally the grip to the surface-contacting member, is disposed to permit tilting of the grip relative to the working surface when the end wall of the surface-contacting member is in intimate contact with the working surface, and is provided with an elongated through slot extending parallel to the axis of the grip and a pin extending into the elongated through slot so as to permit and guide displacement of the grip relative to the surface-contacting member along the axis of the grip. The first sensor module is disposed in the surface-contacting member for sensing two-dimensional movement of the surface-contacting member on the working surface and generating a two-dimensional movement signal according to the two-dimensional movement sensed thereby. The second sensor module is disposed in the grip and includes a resonant circuit operable to generate a resonant frequency that varies according to the displacement of the grip relative to the surface-contacting member along the axis of the grip, and a sensor unit for sensing the resonant frequency of the resonant circuit and generating an axial displacement signal according to the sensed resonant frequency. The processing unit is disposed in the grip, and is electrically coupled to the first and second sensor modules for receiving the two-dimensional movement signal and the axial displacement signal and converting the two-dimensional movement signal and the axial displacement signal into a positioning signal. The transmitting module is electrically coupled to the processing unit for receiving and transmitting the positioning signal.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional stylus input device operable for movement on a touch panel;

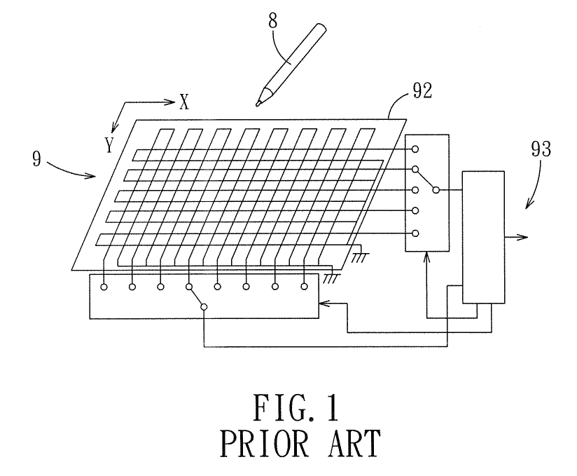

FIG. 2 is a schematic block diagram of a stylus input device of a preferred embodiment according to the present invention, illustrating a transmitting module including a wired transmitting unit electrically connected to a wired receiving unit for transmitting a wired signal corresponding to a positioning signal thereto;

FIG. 3 is a schematic block diagram of a modification of the preferred embodiment, illustrating the transmitting module including a wireless transmitting module transmitting a wireless signal corresponding to the positioning signal to a wireless receiving unit;

FIG. 4 is an exploded perspective view of the preferred embodiment, a portion of the preferred embodiment being omitted for clarity;

FIG. 5 is a schematic side view of the preferred embodiment, illustrating a grip connected to a surface-contacting member by a pivot joint;

FIG. 6 is a schematic side view of the preferred embodiment, illustrating the surface-contacting member being in intimate contact with a working surface and the grip being displaced downwardly relative to the surface-contacting member along an axis of the grip; and

FIG. 7 is a schematic side view of the preferred embodiment, illustrating the surface-contacting member being in intimate contact with the working surface and the grip being tilted relative to the surface-contacting member.

### DETAILED DESCRIPTION OF THE PREFERRED EMBODIMENT

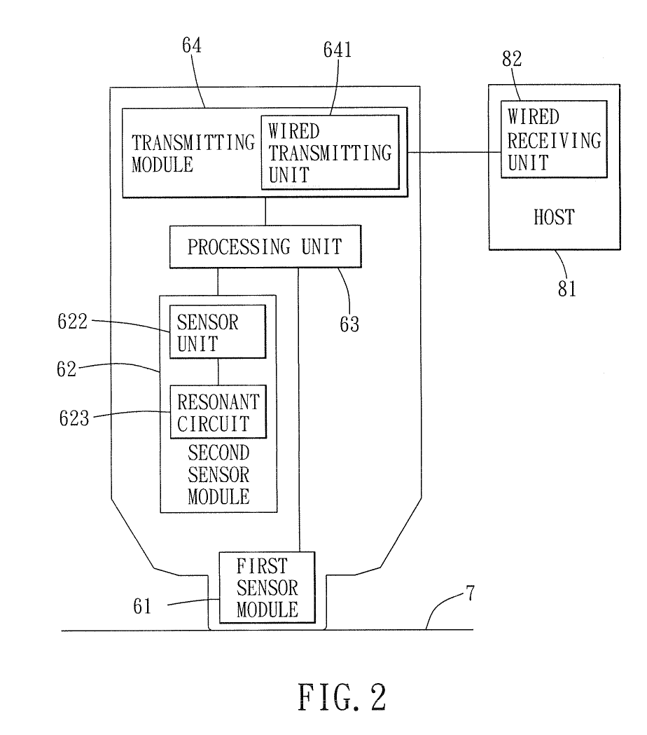

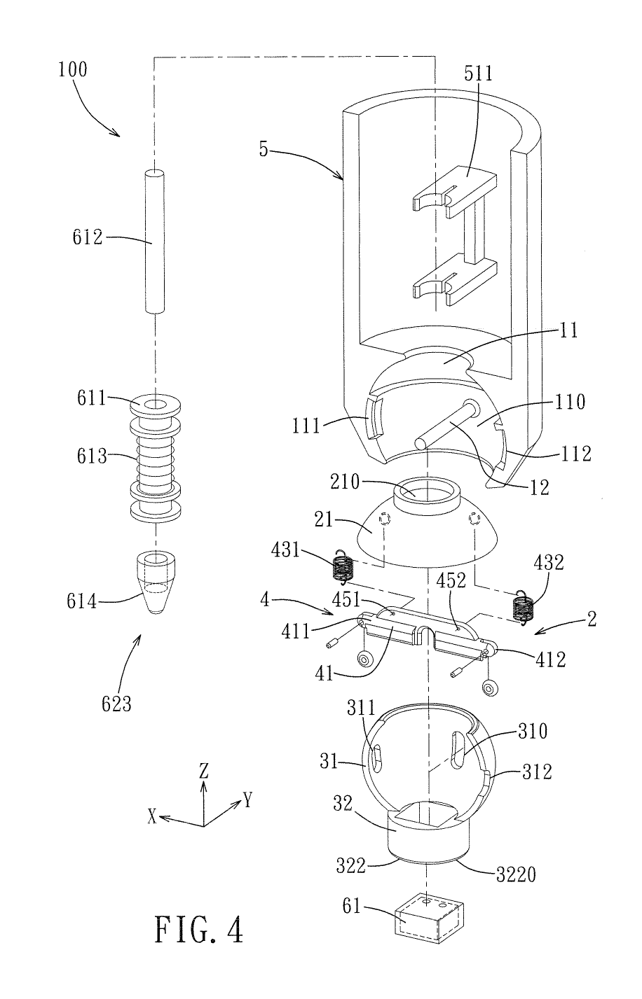

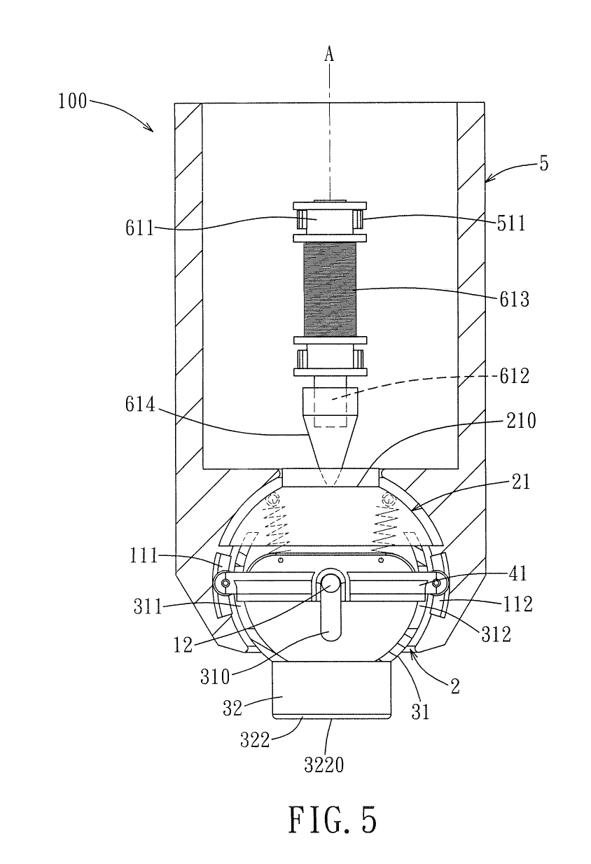

Referring to FIGS. 2, 4 and 5, a preferred embodiment of a stylus input device 100 operable for movement on a working surface 7 according to the present invention is shown to comprise a tubular grip 5, a surface-contacting member 32, a pivot joint 2, first and second sensor modules 61, 62, a processing unit 63, and a transmitting module 64.

The surface-contacting member 32 includes an end wall 322 having a contact surface 3220 for intimate contact with the working surface 7. The grip 5 defines an axis (A) and has a receiving space defining wall 11 that is formed at one end of the grip 5, that defines a receiving space 110 for receiving the pivot joint 2 therein, and that is provided with a pin 12 extending transverse to the axis (A) of the grip 5.

In this embodiment, the pivot joint 2 is a ball and socket joint disposed to connect pivotally the grip 5 to the surface-contacting member 32 and disposed to permit tilting of the grip 5 relative to the working surface 7 when the contact surface 3220 of the end wall 322 of the surface-contacting member 32 is in intimate contact with the working surface 7. The pivot joint 2 includes a socket wall 21, a hollow ball segment 31, and a restoring unit 4.

The hollow ball segment 31 is formed on the surface-contacting member 32, has a portion rotatably confined by the socket wall 21, and is formed with an elongated through slot 310 that extends parallel to the axis (A) of the grip 5 and that permits the pin 12 of the receiving space defining wall 11 to extend therethrough so as to allow and guide displacement of the grip 5 relative to the surface-contacting member 32 along the axis (A) of the grip 5.

The restoring unit 4 is for biasing the grip 5 away from the surface-contacting member 32 and restoring the grip 5 and the surface-contacting member 32 such that the axis (A) of the grip 5 is substantially perpendicular to the contact surface 3220 of the end wall 322 of the surface-contacting member 32 when the end wall 32 of the surface-contacting member 32 is released from intimate contact with the working surface 7. The restoring unit 4 includes a bar component 41, a pair of resilient components 431, 432, a pair of slots 311, 312, and a limiting structure.

The bar component 41 is disposed in the ball segment 31 and has two free ends 411, 412. Each of the resilient components 431, 432 connects the socket wall 21 to a portion 451, 452 of the bar component 41 proximate to a respective one of the free ends 411, 412. The slots 311, 312 are formed in the ball segment 31, and each of the slots 311, 312 permits a respective one of the free ends 411, 412 of the bar component 41 to extend movably therethrough to be movable in a plane transverse to the pin 12.

The limiting structure includes a pair of arc-shaped restraining grooves 111, 112 formed in the receiving defining wall 11 for receiving the free ends 411, 412 of the bar component 41, respectively. The restraining grooves 111, 112 are for limiting angular movement of the bar component 41 in the receiving space 110 about the pin 12, and are configured such that movement of the grip 5 relative to the ball segment 31 causes the receiving space defining wall 11 to abut against the free ends 411, 412 of the bar component 41.

The first sensor module 61 is disposed in the surface-contacting member 32 for sensing two-dimensional movement of the surface-contacting member 32 on the working surface 7 and generates a two-dimensional movement signal (i.e., X-Y coordinate data) according to the two-dimensional movement sensed thereby. Preferably, the first sensor module 61 is a two-dimensional (2D) infrared positioning sensor.

The second sensor module 62 is one of an electromagnetic positioning sensor. The second sensor module 62 is disposed in the grip 5, and includes a sensor unit 622 and a resonant circuit 623. The resonant circuit 623 is operable to generate a resonant frequency that varies according to the displacement of the grip 5 relative to the surface-contacting member 32 along the axis (A) of the grip 5.

In this embodiment, the resonant circuit 623 is an inductor having a configurable inductance and includes a casing 611, a core 612, a sensing coil 613, and a core support 614. The casing 611 is retained by a sensor holder 511 formed in an interior of the grip 5, the sensing coil 613 is wound around the casing 611, and the core 612 is disposed in the casing 611. The core support 614 is spaced apart from the casing 611 along the axis (A) of the grip 5, and is disposed on a supporting surface 210 of the socket wall 21 for supporting the core 612 thereon. The casing 611 and the sensing coil 613 are movable with the grip 5 relative to the core 612.

The sensor unit 622 is for sensing the resonant frequency of the resonant circuit 623 and generating an axial displacement signal (i.e., Z coordinate data) according to the sensed resonant frequency. The processing unit 63 is disposed in the grip 5, and is electrically coupled to the first and second sensor modules 61, 62 for receiving the two-dimensional movement signal and the axial displacement signal and converting the two-dimensional movement signal and the axial displacement signal into a positioning signal. The transmitting module 64 is electrically coupled to the processing unit 63 for receiving and transmitting the positioning signal for subsequent reception by a wired receiving unit 82 of a host 81.

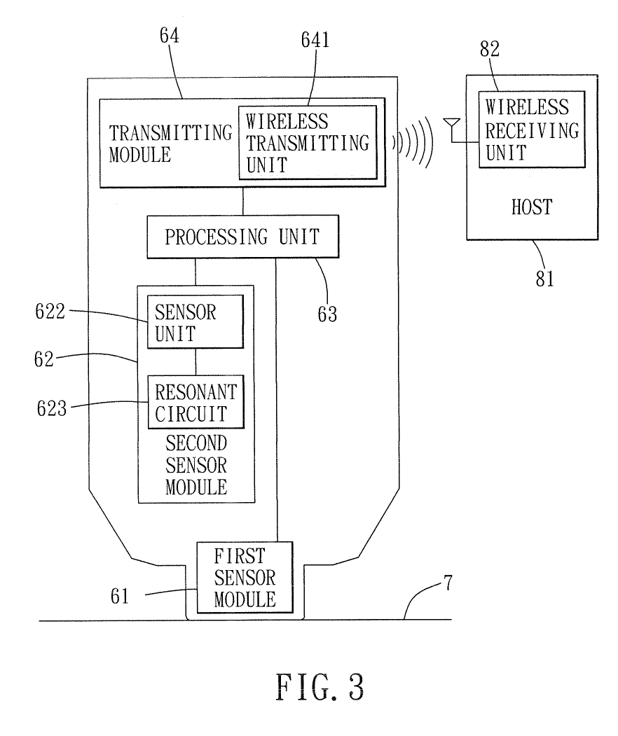

In this embodiment, the transmitting module 64 includes a wired transmitting unit 641 for outputting a wired signal corresponding to the positioning signal. Referring to FIG. 3, it can be appreciated that the transmitting module 64 may include a wireless transmitting unit 642 for outputting a wireless signal corresponding to the positioning signal, and the receiving unit may be a wireless receiving unit 82. Additionally, the resonant circuit 623 can be configured as a capacitor in other embodiments of this invention.

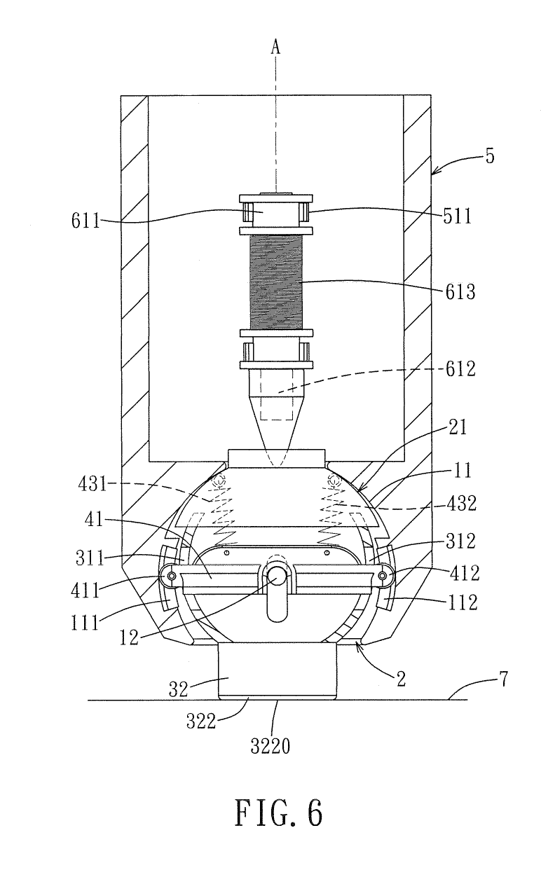

Further referring to FIG. 6, when the contact surface 3220 of the end wall 322 of the surface-contacting member 32 is in intimate contact with the working surface 7 and the grip 5 is forced to displace toward the surface-contacting member 32 along the axis (A), the casing 611 and the sensing coil 613 move relative to the core 612 to generate induced current that is to be sensed by the sensor unit 622. At the same time, the receiving space defining wall 11 of the grip 5 abuts against the free ends 411, 412 of the bar component 41 to move the bar component 41 downwardly relative to the socket wall 21 along the axis (A). Consequently, the resilient members 431, 432 are stretched resiliently to thereby store a restoring force. Afterwards, when the force applied on the grip 5 is released, the grip 5 is biased away from the surface-contacting member 32 by the restoring force of the resilient members 431, 432.

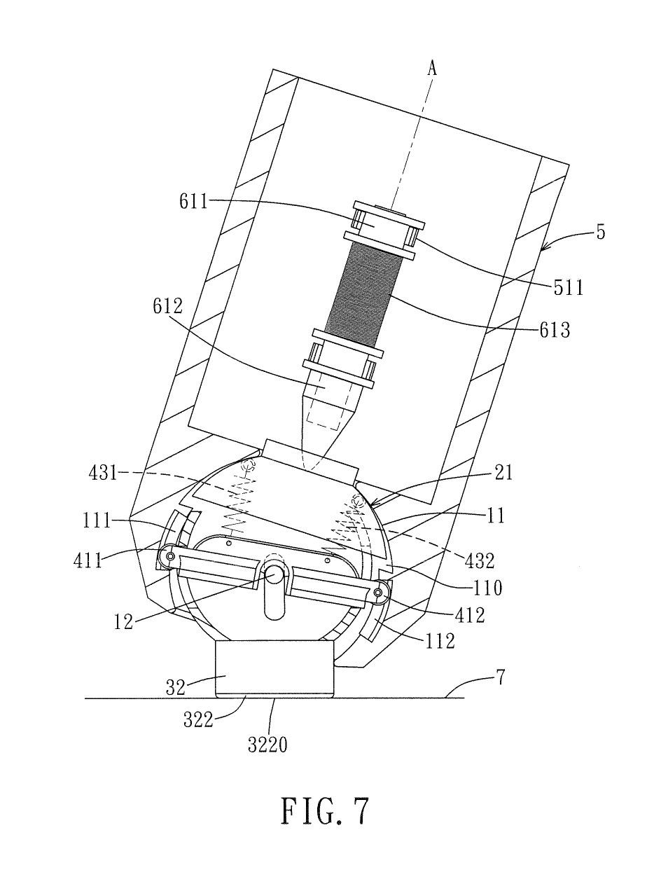

Referring to FIG. 7, when the contact surface 3220 of the end wall 32 of the surface-contacting member 32 is in intimate contact with the working surface 7 and the grip 5 is forced to tilt relative to the working surface 7, the receiving space defining wall 11 abuts against the free ends 411, 412 and causes angular movement of the bar component 41 in the receiving space 110 about the pin 12. One of the resilient members 431 is stretched and the other one of the resilient members 432 is compressed. Subsequently, when either the force applied on the grip 5 is released or the end wall 32 of the surface-contacting member 32 is released from intimate contact with the working surface 7, the resilient members 431, 432 restore the grip 5 and the surface-contacting member 32 such that the axis (A) of the grip 5 is substantially perpendicular to the contact surface 3220 of the end wall 322 of the surface-contacting member 32.

Therefore, the stylus input device 100 of the present invention can be used with various touch panels and generate a three-dimensional positioning signal.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A stylus input device operable for movement on a working surface, said stylus input device comprising:
a grip defining an axis;
a surface-contacting member including an end wall configured for intimate contact with the working surface;
a pivot joint disposed to connect pivotally said grip to said surface-contacting member, disposed to permit tilting of said grip relative to the working surface when said end wall of said surface-contacting member is in intimate contact with the working surface, and provided with an elongated through slot extending parallel to the axis of said grip and a pin extending into said elongated through slot so as to permit and guide displacement of said grip relative to said surface-contacting member along the axis of said grip;
a first sensor module disposed in said surface-contacting member for sensing two-dimensional movement of said surface-contacting member on the working surface and generating a two-dimensional movement signal according to the two-dimensional movement sensed thereby;
a second sensor module disposed in said grip and including a resonant circuit operable to generate a resonant frequency that varies according to the displacement of said grip relative to said surface-contacting member along the axis of said grip, and a sensor unit for sensing the resonant frequency of said resonant circuit and generating an axial displacement signal according to the sensed resonant frequency;
a processing unit disposed in said grip, electrically coupled to said first and second sensor modules for receiving the two-dimensional movement signal and the axial displacement signal and converting the two-dimensional movement signal and the axial displacement signal into a positioning signal; and
a transmitting module electrically coupled to said processing unit for receiving and transmitting the positioning signal.

2. The stylus input device as claimed in claim 1, wherein said grip has a receiving space defining wall formed at one end of said grip and defining a receiving space for receiving said pivot joint therein,
said pivot joint being a ball and socket joint and including:
a socket wall having a supporting surface for supporting said resonant circuit thereon; and
a hollow ball segment formed on said surface-contacting member and having a portion rotatably confined by said socket wall.

3. The stylus input device as claimed in claim 2, wherein one of said ball segment and said receiving space defining wall is formed with said through slot, and the other of said ball segment and said receiving space defining wall is provided with said pin.

4. The stylus input device as claimed in claim 2, wherein said end wall of said surface-contacting member has a contact surface, and said pivot joint further includes a restoring unit for biasing said grip away from said surface-contacting member and restoring said grip and said surface-contacting member such that the axis of said grip is substantially perpendicular to said contact surface of said end wall of said surface-contacting member when said end wall of said surface-contacting member is released from intimate contact with the working surface.

5. The stylus input device as claimed in claim 4, wherein said pin extends transverse to the axis of said grip, and said restoring unit includes:
a bar component disposed in said ball segment and having two free ends;
a pair of resilient components, each connecting said socket wall to a portion of said bar component proximate to a respective one of said free ends;
a pair of slots formed in said ball segment, each of said slots permitting a respective one of said free ends of said bar component to extend movably therethrough to be movable in a plane transverse to said pin; and
a limiting structure provided on said receiving space defining wall for limiting angular movement of said bar component in said receiving space about said pin.

6. The stylus input device as claimed in claim 5, wherein said limiting structure includes a pair of arc-shaped restraining grooves formed in said receiving defining wall for receiving said free ends of said bar component, respectively, and configured such that movement of said grip relative to said ball segment causes said receiving space defining wall to abut against said free ends of said bar component.

7. The stylus input device as claimed in claim 6, wherein said grip is tubular and has a sensor holder formed in an interior thereof for retaining said second sensor module.

8. The stylus input device as claimed in claim 7, wherein said second sensor module includes:
a casing retained by said sensor holder;
a sensing coil wound around said casing;
a core disposed in said casing, said casing and said sensing coil being movable with said grip relative to said core; and
a core support spaced apart from said casing along the axis of said grip, and disposed on said supporting surface of said socket wall for supporting said core thereon.

9. The stylus input device as claimed in claim 1, wherein said first sensor module is a two-dimensional infrared positioning sensor and said second sensor module is an electromagnetic positioning sensor.

10. The stylus input device as claimed in claim 1, wherein said transmitting module includes at least one of a wired transmission unit and a wireless transmission unit for outputting a corresponding one of a wired signal and a wireless signal according to the positioning signal.

11. The stylus input device as claimed in claim 1, wherein said end wall of said surface-contacting member has a contact surface, and said pivot joint includes are storing unit for biasing said grip away from said surface-contacting member and restoring said grip and said surface-contacting member such that the axis of said grip is substantially perpendicular to said contact surface of said end wall of said surface-contacting member when said end wall of said surface-contacting member is released from intimate contact with the working surface. 12. The stylus input device as claimed in claim 2, wherein said grip is tubular and has a sensor holder formed in an interior thereof for retaining said second sensor module, and said second sensor module includes:
a casing retained by said sensor holder;
a sensing coil wound around said casing;
a core disposed in said casing, said casing being movable with said grip relative to said core; and
a core support spaced apart from said casing along the axis of said grip, and disposed on said supporting surface of said socket wall for supporting said core thereon.
